(19) United States
(12) Patent Application Publication
(10) Pub. No.: US 2007/0070028 A1
(43) Pub. Date: Mar. 29, 2007

(54) Electrophoretic display with improved image quality using rest pulses and hardware driving

(75) Inventors: Guofu Zhou, Best (NL); Mark T. Johnson, Veldhoven (NL); Neculai Ailenei, Landgraef (NL); Jan Van De Kamer, Heerfen (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/571,328

(22) PCT Filed: Sep. 7, 2004
(86) PCT No.: PCT/IB04/51703

§ 371 Date: Mar. 8, 2006

Related U.S. Application Data
(60) Provisional application No. 60/502,030, filed on Sep. 11, 2003.

(51) Int. Cl. G09G 3/34

(52) U.S. Cl. 345/107

(57) ABSTRACT

Image quality is improved when updating a display image (310) in a bi-stable electronic reading device (300, 400) such as one using an electrophoretic display by applying rest pulses (R1, R2) adjacent to and following hardware driving pulses (S1, S2). The voltage of the rest pulses (R1, R2) is zero or otherwise below a threshold for moving particles that form the bi-stable display.

The invention relates generally to electronic reading devices such as electronic books and electronic newspapers and, more particularly, to a method and apparatus for updating an image with improved image quality using a drive waveform that includes rest pulses.

Recent technological advances have provided “user friendly” electronic reading devices such as e-books that open up many opportunities. For example, electrophoretic displays hold much promise. Such displays have an intrinsic memory behavior and are able to hold an image for a relatively long time without power consumption. Power is consumed only when the display needs to be refreshed or updated with new information. So, the power consumption in such displays is very low, suitable for applications for portable e-reading devices like e-books and e-newspaper. Electrophoresis refers to movement of charged particles in an applied electric field. When electrophoresis occurs in a liquid, the particles move with a velocity determined primarily by the viscous drag experienced by the particles, their charge (either permanent or induced), the dielectric properties of the liquid, and the magnitude of the applied field. An electrophoretic display is a type of bi-stable display, which is a display that substantially holds an image without consuming power after an image update.

For example, international patent application WO 99/53373, published Apr. 9, 1999, by E Ink Corporation, Cambridge, Mass., US, and entitled Full Color Reflective Display With Multichromatic Sub-Pixels, describes such a display device. WO 99/53373 discusses an electronic ink display having two substrates. One is transparent, and the other is provided with electrodes arranged in rows and columns. A display element or pixel is associated with an intersection of a row electrode and column electrode. The display element is coupled to the column electrode using a thin film transistor (TFT), the gate of which is coupled to the row electrode. This arrangement of display elements, TFT transistors, and row and column electrodes together forms an active matrix. Furthermore, the display element comprises a pixel electrode. A row driver selects a row of display elements, and a column or source driver supplies a data signal to the selected row of display elements via the column electrodes and the TFT transistors. The data signals correspond to graphic data to be displayed, such as text or figures.

The electronic ink is provided between the pixel electrode and a common electrode on the transparent substrate. The electronic ink comprises multiple microcapsules of about 10 to 50 microns in diameter. In one approach, each microcapsule has positively charged white particles and negatively charged black particles suspended in a liquid carrier medium or fluid. When a positive voltage is applied to the pixel electrode, the white particles move to a side of the microcapsule directed to the transparent substrate and a viewer will see a white display element. At the same time, the black particles move to the pixel electrode at the opposite side of the microcapsule where they are hidden from the viewer. By applying a negative voltage to the pixel electrode, the black particles move to the common electrode at the side of the microcapsule directed to the transparent substrate and the display element appears dark to the viewer. At the same time, the white particles move to the pixel electrode at the opposite side of the microcapsule where they are hidden from the viewer. When the voltage is removed, the display device remains in the acquired state and thus exhibits a bi-stable character. In another approach, particles are provided in a dyed liquid. For example, black particles may be provided in a white liquid, or white particles may be provided in a black liquid. Or, other colored particles may be provided in different colored liquids, e.g., white particles in green liquid.

Other fluids such as air may also be used in the medium in which the charged black and white particles move around in an electric field (see, e.g., Bridgestone SID2003-Symposium on Information Displays. May 18-23, 2003,—digest 20.3). Colored particles may also be used.

To form an electronic display, the electronic ink may be printed onto a sheet of plastic film that is laminated to a layer of circuitry. The circuitry forms a pattern of pixels that can then be controlled by a display driver. Since the microcapsules are suspended in a liquid carrier medium, they can be printed using existing screen-printing processes onto virtually any surface, including glass, plastic, fabric and even paper. Moreover, the use of flexible sheets allows the design of electronic reading devices that approximate the appearance of a conventional book.

Grey scales or intermediate optical states can be created in the display device by controlling the amount of particles that move to the common electrode at the top of the microcapsules. For example, the energy of the positive or negative electric field, defined as the product of field strength and time of application, controls the amount of particles which move to the top of the microcapsules.

In accordance with the invention, robust driving schemes are proposed for an active matrix electrophoretic display. A rest pulse with a voltage level substantially equal to zero and a time period of at least one frame time is applied in a drive waveform immediately after the complete of a shaking pulse and prior to the start of a driving pulse or a reset pulse when a shaking pulse is incorporated using “hardware shaking”. Hardware shaking” is an example of a more generic form of driving pulses, known as “hardware driving”, and may be used exchangeably within the text as such. When using hardware driving, the display is defined to operate in a mode whereby more than one line of the display is supplied with data at the same time, for example by operating more than one driver IC, such as select drivers, in parallel, or by providing multiple simultaneous outputs from a single driver IC. Another example of hardware driving pulses may be the longer duration AC pulses used to initialize a display, for example by alternatively switching the entire display between one extreme optical state, e.g. white, and a second extreme optical state, e.g. black. In the absence of a rest pulse, the final portion of the hardware shaking will leave all pixel electrodes at a residual finite voltage, and usually at either the maximum positive or the maximum negative voltage. For any pixels which are not addressed in the temporally following frame period, the residual voltage will cause unwanted movement of the particles, and a degradation of the image quality. Examples of pixels which are not addressed in the temporally following frame period are pixels which are situated in a portion of a display outside a window where a partial display image is being updated, or pixels being driven by shorter waveforms, which do not begin directly after the hardware shaking pulses are completed.

By adding a rest pulse, the source driver is timely discharged after the completion of the hardware shaking pulse, thus the image quality is largely improved. This is true in particular on pixels using relatively short drive waveforms, in which the non-zero voltage pulse such as driving or reset pulses may not immediately follow the hardware shaking pulse, for example, for obtaining a smoother update process. Moreover, the rest pulse can be applied to the entire display or to a portion of the display. For example, when a single display screen provides two regions for two pages, the rest pulses can be applied to only one of the pages.

In a particular aspect of the invention, a method for updating an image on an electronic reading device includes applying at least a first hardware driving pulse to a bi-stable display of the electronic reading device, and applying a rest pulse with at least one frame time period temporally adjacent to and following the at least a first hardware driving pulse. The rest pulse has a voltage level that is substantially zero or at least below a threshold for moving particles that form the bi-stable display. The threshold voltage is often below 0.5 V depending on the material systems used.

A related electronic reading device and program storage device are also provided.

In the drawings:

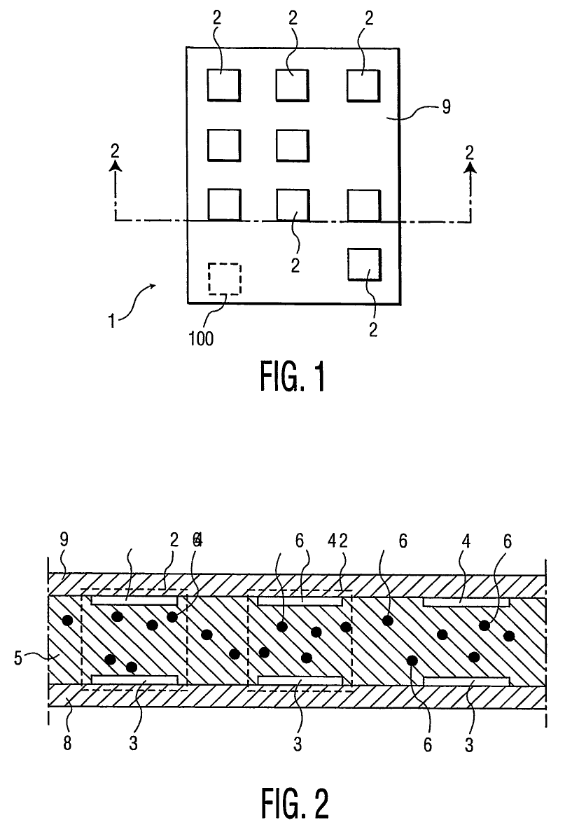

FIG. 1 shows diagramatically a front view of an embodiment of a portion of a display screen of an electronic reading device;

FIG. 2 shows diagramatically a cross-sectional view along 2-2 in FIG. 1;

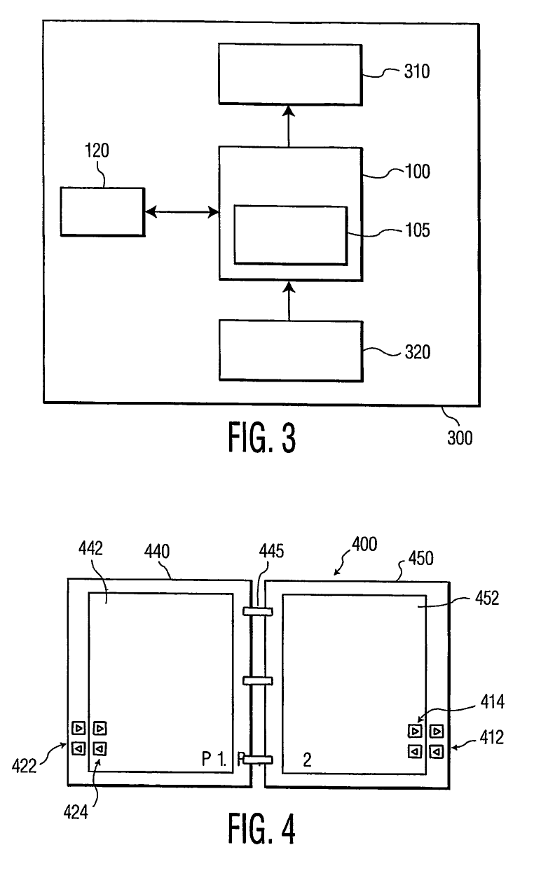

FIG. 3 shows diagramatically an overview of an electronic reading device;

FIG. 4 shows diagramatically two display screens with respective display regions;

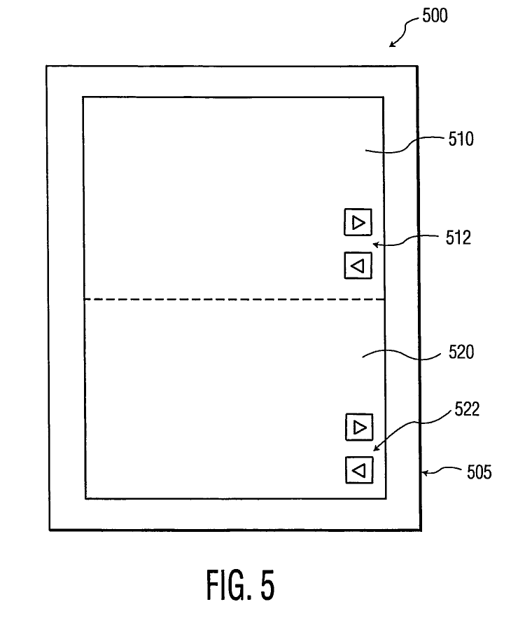

FIG. 5 shows diagramatically a display screen divided into two display regions;

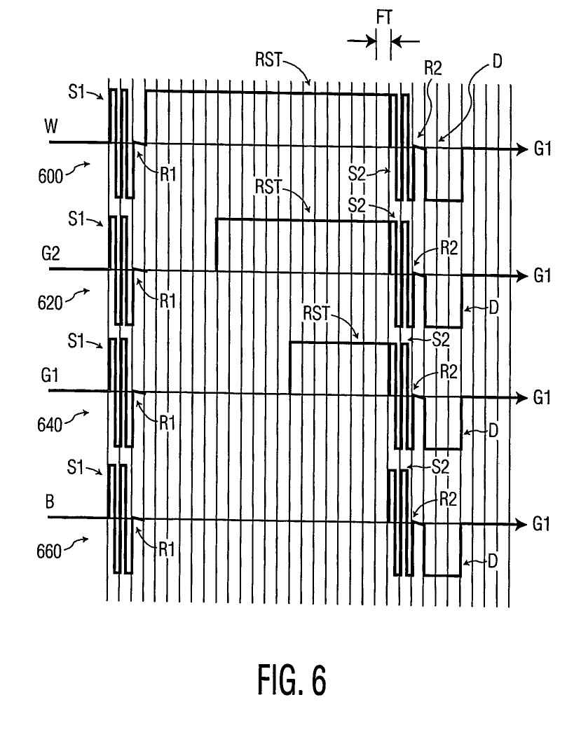

FIG. 6 illustrates waveforms in which a rest pulse with a period of a standard frame time is applied after first shaking pulses, a reset pulse, and second shaking pulses;

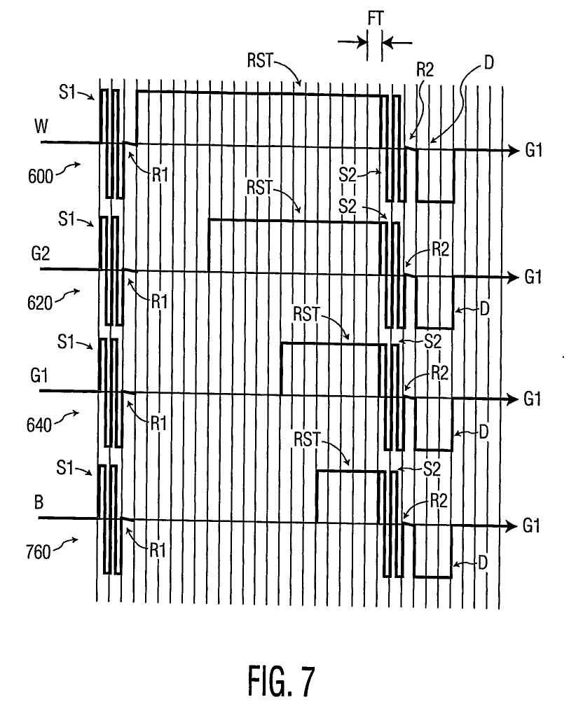

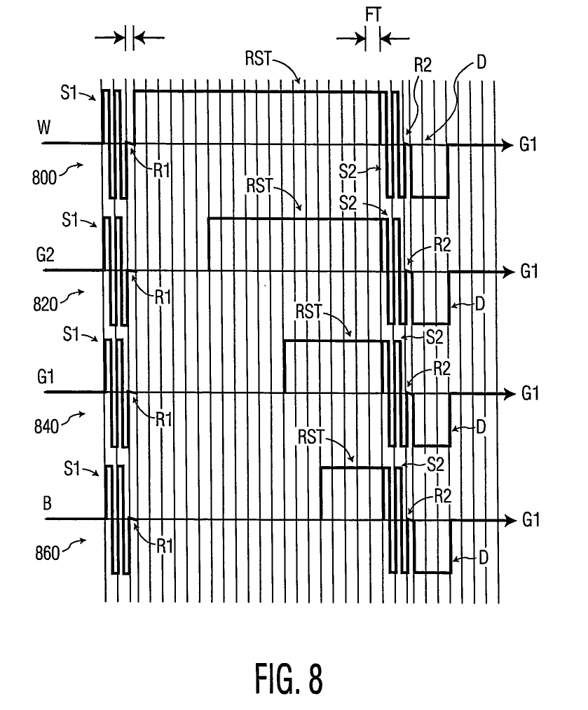

FIG. 7 illustrates waveforms corresponding to those of FIG. 6, but where a reset pulse is applied in the black to dark grey transition;

FIG. 8 illustrates waveforms corresponding to those of FIG. 7, but where the rest pulses applied after the first and second shaking pulses have a hardware shaking frame time period;

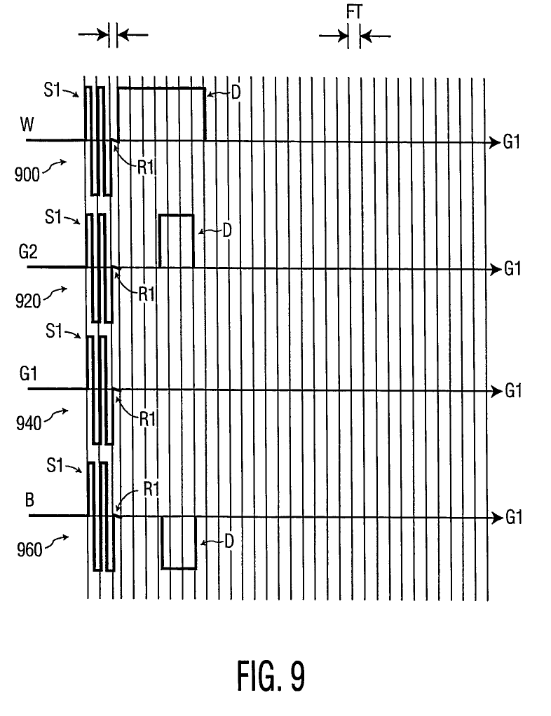

FIG. 9 illustrates waveforms in which a rest pulse with a period of a hardware shaking frame time is applied after shaking pulses, no reset pulse is used, and drive pulses follow the rest pulses at different times; and

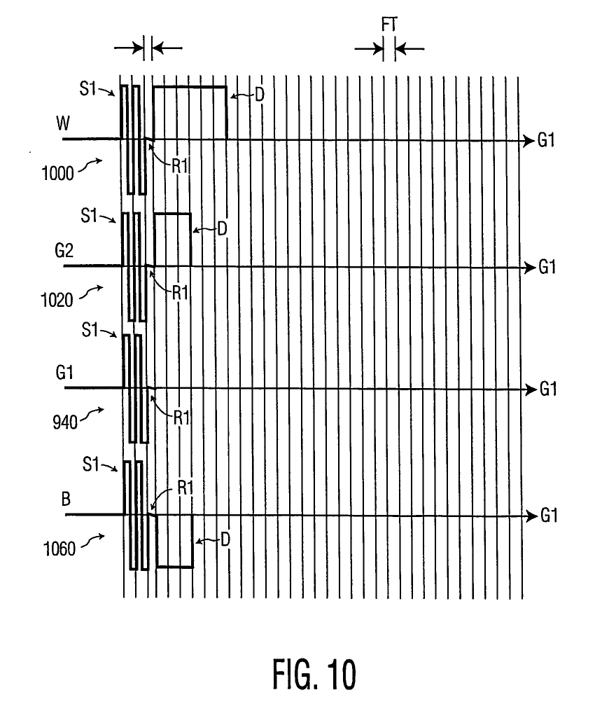

FIG. 10 illustrates waveforms corresponding to those of FIG. 9, but where the drive pulses follow the rest pulses starting at the same time.

In all the Figures, corresponding parts are referenced by the same reference numerals.

FIGS. 1 and 2 show the embodiment of a portion of a display panel 1 of an electronic reading device having a first substrate 8, a second opposed substrate 9 and a plurality of picture elements 2. The picture elements 2 may be arranged along substantially straight lines in a two-dimensional structure. The picture elements 2 are shown spaced apart from one another for clarity, but in practice, the picture elements 2 are very close to one another so as to form a continuous image. Moreover, only a portion of a full display screen is shown. Other arrangements of the picture elements are possible, such as a honeycomb arrangement. An electrophoretic medium 5 having charged particles 6 is present between the substrates 8 and 9. A first electrode 3 and second electrode 4 are associated with each picture element 2. The electrodes 3 and 4 are able to receive a potential difference. In FIG. 2, for each picture element 2, the first substrate has a first electrode 3 and the second substrate 9 has a second electrode 4. The charged particles 6 are able to occupy positions near either of the electrodes 3 and 4 or intermediate to them. Each picture element 2 has an appearance determined by the position of the charged particles 6 between the electrodes 3 and 4. Electrophoretic media 5 are known per se, e.g., from U.S. Pat. Nos. 5,961,804, 6,120,839, and 6,130,774 and can be obtained, for instance, from E Ink Corporation.

As an example, the electrophoretic medium 5 may contain negatively charged black particles 6 in a white fluid. When the charged particles 6 are near the first electrode 3 due to a potential difference of, e.g., +15 Volts, the appearance of the picture elements 2 is white. When the charged particles 6 are near the second electrode 4 due to a potential difference of opposite polarity, e.g., −15 Volts, the appearance of the picture elements 2 is black. When the charged particles 6 are between the electrodes 3 and 4, the picture element has an intermediate appearance such as a grey level between black and white. A drive control 100 controls the potential difference of each picture element 2 to create a desired picture, e.g. images and/or text, in a full display screen. The full display screen is made up of numerous picture elements that correspond to pixels in a display.

FIG. 3 shows diagramatically an overview of an electronic reading device. The electronic reading device 300 includes the control 100, including an addressing circuit 105. The control 100 controls the one or more display screens 310, such as electrophoretic screens, to cause desired text or images to be displayed. For example, the control 100 may provide voltage waveforms to the different pixels in the display screen 310. The addressing circuit provides information for addressing specific pixels, such as row and column, to cause the desired image or text to be displayed. As described further below, the control 100 causes successive pages to be displayed starting on different rows and/or columns. The image or text data may be stored in a memory 120. One example is the Philips Electronics small form factor optical (SFFO) disk system. The control 100 may be responsive to a user-activated software or hardware button 320 that initiates a user command such as a next page command or previous page command.

The control 100 may be part of a computer that executes any type of computer code devices, such as software, firmware, micro code or the like, to achieve the functionality described herein. Accordingly, a computer program product comprising such computer code devices may be provided in a manner apparent to those skilled in the art. Moreover, the memory 120 is a program storage device that tangibly embodies a program of instructions executable by a machine such as the control 100 or a computer to perform a method that achieves the functionality described herein. Such a program storage device may be provided in a manner apparent to those skilled in the art. The control 100 may have logic for periodically providing a forced reset of a display region of an electronic book, e.g., after every x pages are displayed, after every y minutes, e.g., ten minutes, when the electronic reading device is first turned on, and/or when the brightness deviation is larger than a value such as 3% reflection. For automatic resets, an acceptable frequency can be determined empirically based on the lowest frequency that results in acceptable image quality. Also, the reset can be initiated manually by the user via a function button or other interface device, e.g., when the user starts to read the electronic reading device, or when the image quality drops to an unacceptable level.

The invention may be used with any type of electronic reading device. FIG. 4 illustrates one possible example of an electronic reading device 400 having two separate display screens. Specifically, a first display region 442 is provided on a first screen 440, and a second display region 452 is provided on a second screen 450. The screens 440 and 450 may be connected by a binding 445 that allows the screens to be folded flat against each other, or opened up and laid flat on a surface. This arrangement is desirable since it closely replicates the experience of reading a conventional book.

Various user interface devices may be provided to allow the user to initiate page forward, page backward commands and the like. For example, the first region 442 may include on-screen buttons 424 that can be activated using a mouse or other pointing device, a touch activation, PDA pen, or other known technique, to navigate among the pages of the electronic reading device. In addition to page forward and page backward commands, a capability may be provided to scroll up or down in the same page. Hardware buttons 422 may be provided alternatively, or additionally, to allow the user to provide page forward and page backward commands. The second region 452 may also include on-screen buttons 414 and/or hardware buttons 412. Note that the frame 405 around the first and second display regions 442, 452 is not required as the display regions may be frameless. Other interfaces, such as a voice command interface, may be used as well. Note that the buttons 412, 414; 422, 424 are not required for both display regions. That is, a single set of page forward and page backward buttons may be provided. Or, a single button or other device, such as a rocker switch, may be actuated to provide both page forward and page backward commands. A function button or other interface device can also be provided to allow the user to manually initiate a reset.

In other possible designs, an electronic book has a single display screen with a single display region that displays one page at a time. Or, a single display screen may be partitioned into or two or more display regions arranged, e.g., horizontally or vertically. For example, FIG. 5 illustrates an electronic reading device 500 with display regions 510 and 520. A frame 505 is provided around the display regions 510 and 520. On-screen buttons 512 and 522 are provided for the display regions 510 and 520, respectively. When the device 500 is updated, a partial image update may occur by updating only one of the display regions 510 or 520. In any case, the invention can be used with each display region to reduce image retention effects.

Furthermore, when multiple display regions are used, successive pages can be displayed in any desired order. For example, in FIG. 4, a first page can be displayed on the display region 442, while a second page is displayed on the display region 452. When the user requests to view the next page, a third page may be displayed in the first display region 442 in place of the first page while the second page remains displayed in the second display region 452. Similarly, a fourth page may be displayed in the second display region 452, and so forth. In another approach, when the user requests to view the next page, both display regions are updated so that the third page is displayed in the first display region 442 in place of the first page, and the fourth page is displayed in the second display region 452 in place of the second page. When a single display region is used, a first page may be displayed, then a second page overwrites the first page, and so forth, when the user enters a next page command. The process can work in reverse for page back commands. Moreover, the process is equally applicable to languages in which text is read from right to left, such as Hebrew, as well as to languages such as Chinese in which text is read column-wise rather than row-wise.

Additionally, note that the entire page need not be displayed on the display region. A portion of the page may be displayed and a scrolling capability provided to allow the user to scroll up, down, left or right to read other portions of the page. A magnification and reduction capability may be provided to allow the user to change the size of the text or images. This may be desirable for users with reduced vision, for example.

Discussion of Rest Pulses

From the non-pre-published patent applications in accordance with applicants docket referred to as PHNL020441 and PHNL030091, which have been filed as European patent applications 02077017.8 and 03100133.2, respectively, image retention can be minimized by using preset pulses (also referred to as the shaking pulse). Preferably, the shaking pulse comprises a series of AC-pulses, however, the shaking pulse may comprise a single preset pulse only. The pre-published patent applications are directed to the use of shaking pulses, either directly before the drive pulses, or directly before the reset pulses. PHNL030091 further discloses that the picture quality can be improved by extending the duration of the reset pulse which is applied before the drive pulse. An over-reset pulse is added to the reset pulse, the over-reset pulse and the reset pulse together, have an energy which is larger than required to bring the pixel into one of two limit optical states. The duration of the over-reset pulse may depend on the required transition of the optical state. Unless explicitly mentioned, for the sake of simplicity, the term reset pulse may cover both the reset pulse without the over-reset pulse or the combination of the reset pulse and the over-reset pulse. By using the reset pulse, the pixels are first brought into one of two well-defined limit states before the drive pulse changes the optical state of the pixel in accordance with the image to be displayed. This improves the accuracy of the grey levels.

For example, if black and white particles are used, the two limit optical states are black and white. In the limit state black, the black particles are at a position near to the transparent substrate and, in the limit state white, the white particles are at a position near to the transparent substrate.

The drive pulse has an energy to change the optical state of the pixel to a desired level which may be in-between the two limit optical states. Also the duration of the drive pulse may depend on the required transition of the optical state.

The non-prepublished patent application PHNL030091 discloses in an embodiment that the shaking pulse precedes the reset pulse. Each level (which is one preset pulse) of the shaking pulse has an energy (or a duration if the voltage level is fixed) sufficient to release particles present in one of the extreme positions, but insufficient to enable said particles to reach the other one of the extreme positions. The shaking pulse increases the mobility of the particles such that the reset pulse has an immediate effect. If the shaking pulse comprises more than one preset pulse, each preset pulse has the duration of a level of the shaking pulse. For example, if the shaking pulse has successively a high level, a low level and a high level, this shaking pulse comprises three preset pulses. If the shaking pulse has a single level, only one preset pulse is present.

The complete voltage waveform which has to be presented to a pixel during an image update period is referred to as the drive voltage waveform. The drive voltage waveform usually differs for different optical transitions of the pixels.

A further important concept is the rail-stabilized approach for driving a bi-stable display. In particular, it has recently been established that accurate grey levels in a bi-stable display such as an e-ink type electrophoretic display can be achieved using a rail-stabilized approach, which means that the grey levels are always achieved either from a reference black or white level (the two rails or extreme greyscale levels). In particular, the current grey level is driven to one of the rails using a reset pulse, and a subsequent drive pulse drives the pixel to the desired new grey level. The pulse sequence may include four portions: a first shaking pulse (S1), a reset pulse (R), a second shaking pulse (S2) and a greyscale driving pulse (D).

This method is schematically shown in FIG. 6 for image transitions from white (W) to dark grey (G1) (waveform 600), light grey (G2) to dark grey (G1) (waveform 620), dark grey (G1) to dark grey (G1) (waveform 640), and black (13) to dark grey (G1) (waveform 660). The four transitions to the G1 level from W, G2, G1, B are realized using four types of waveforms with different reset time periods for resetting the display to reference black. In this example, the DC-balanced driving with a smooth image update is provided. Optionally, a reset pulse is applied in two portion, where the second set of data-independent shaking pulses (S2) is applied well before completion of the entire over-reset pulse, e.g., after the first portion but before the second portion, independent of the image update sequences. Shaking pulses result in a more accurate image since they increase the momentum of the particles to enable them to respond more quickly to a subsequent reset or drive pulse. While individual shaking pulses can be applied to each pixel, this results in increased power consumption. Accordingly, hardware shaking pulses may be used. As discussed previously, “hardware shaking” is an example of a more generic form of driving pulses, known as “hardware driving”. When using hardware driving, the display is defined to operate in a mode whereby more than one line of the display is supplied with data at the same time, for example by operating more than one driver IC, such as select drivers, in parallel, or by providing multiple simultaneous outputs from a single driver IC. In one embodiment, hardware driving may even refer to applying the same driving pulse to all pixels in the display concurrently, independent of the specific grey level provided by each pixel. However, when hardware-driving pulses are used, the image quality is negatively influenced in any pixel where the voltage is not set to a value below the threshold value in the temporally adjacent and following frame.

Still referring to FIG. 6, a rest pulse with a period of a standard frame time (FT) is applied after first shaking pulses and second shaking pulses. In particular, a rest pulse (R1) is used after the first shaking pulses (S1), and a rest pulse (R2) is used after the second shaking pulses (S2). The rest pulses (R1, R2) are therefore temporally adjacent to, and following, the shaking pulses (S1, S2). The drive pulse (D) follows at the end of the waveforms 600, 620, 640 and 660. It was experimentally observed in active matrix display panels that some areas of the display are wrongly updated during new image updates, leading to large greyscale errors where pixels are not set to a voltage below the threshold voltage in the temporally adjacent and following frame. The rest pulses (R1, R2) have a time period or duration of a standard frame time (FT), which may be substantially the same as the frame time of all other pulses. The rest pulse (R2) following the reset pulse (RST) discharges the source driver to zero volts, which is particularly needed for pixels that do not receive non-zero data voltage levels.

According to the invention, after the introduction of a post-rest pulse, e.g., a rest pulse after a shaking pulse, in all waveforms, this problem is massively reduced. It seems that the voltage has not been removed from all pixels at the time the hardware shaking is completed. This may disturb the image update, especially for pixels outside a partial image window, or pixels with short drive waveforms, as it may be many frame periods before these pixels are addressed, leading to large errors. Advantageously, this interrupt effect is effectively reduced by using rest pulses.

The rest pulse has a voltage level that is below a threshold for moving particles that form the bi-stable display. The threshold may be less than about 0.5 V, e.g., substantially zero. To provide a rest pulse, the control 100 provides a signal to a source driver of the display to provide an output of substantially zero volts. The source driver may otherwise still be on, e.g., providing an output of positive or negative 15 Volts, until the rest pulse is provided. In a preferred case, the rest pulse is applied to all pixels in a display. In particular, to limit power consumption, the rest pulse may also be applied in a “hardware” manner. However, it is also possible to apply the rest pulse to only a portion of the pixels in a display, such as to the pixels in one of the display regions 510 and 520 in FIG. 5.

Note that the reset pulse has a duration that is sufficient to drive the particles in the display to a black level. The subsequent drive pulse (D) then drives the particles to the desired ending level, which in the example shown is dark grey (G1). There is no need for a reset pulse in the black (B) to dark grey (G1) transition since the display is already at the black level. The reset duration is proportional to the distance of the particles from the black level. Thus, the reset duration is longer for particles at the white level than for particles at a light grey or dark grey level. Omission of a rest pulse will therefore be most serious for pixels with a short reset pulse duration, such as the light grey pixels.

FIG. 7 illustrates waveforms corresponding to those of FIG. 6, but where a reset pulse (RST) is applied in the black (B) to dark grey (G1) transition in waveform 760. This increases greyscale accuracy since the black level may have drifted to a lighter level. The reset pulse in the waveform 760 ensures that the display is reset back to the black level.

FIG. 8 illustrates waveforms corresponding to those of FIG. 7, but where the rest pulses applied after the first and second shaking pulses have a hardware shaking frame time period. In particular, the rest pulses that follow the first and second shaking pulses in waveforms 800, 820, 840 and 860, e.g., R1 following S1, and R2 following S2, have a frame time period that is substantially the same as that of the shaking pulses (S1, S2). This is favorable because it reduces a vertical cross talk that may be induced by the changing of the frame time. Also, the total image update time is reduced. Note that the hardware shaking frame time is typically much shorter than the standard frame time used by the reset pulse (RST).

FIG. 9 illustrates waveforms in which a rest pulse with a period of a hardware shaking frame time is applied after shaking pulses, no reset pulse is used, and drive pulses follow the rest pulses at different times. In this driving scheme, the dark grey-to-dark grey transition of waveform 940 is realized directly, not via an extreme black or white rail level, so no reset pulse is required, and only one set of shaking pulses is needed. A rest pulse (V=0) with a time period of the hardware shaking frame time is used after the hardware shaking pulse (S1) and prior to the drive pulse (D). The drive pulses do not start at the same time in the different waveforms 900, 920, 940 and 960. Moreover, the drive pulses may end at the same time or different times. For the white-to-dark grey transition of waveform 900, the drive pulse has a duration that is sufficient to bring the particles directly to the dark grey level without first going to the “rail”, or boundary condition, of the black level. Similarly, for the white-to-light grey transition of waveform 920, the drive pulse has a duration that is sufficient to bring the particles directly to the dark grey level. For the waveform 940, the particles are already at the dark grey level, no drive pulse is needed. For the waveform 960, the drive pulse has a polarity and duration that is sufficient to bring the particles directly to the dark grey level.

This approach is advantageous because the total image update time is significantly reduced. Here, without the rest pulse, image quality problems may occur for transitions G2 to G1 and B to G1, where pixels are not set to a value below the threshold value in the temporally adjacent and following frame.

FIG. 10 illustrates waveforms corresponding to those of FIG. 9, but where the drive pulses follow the rest pulses starting at the same time. For the waveforms 1000, 1020, and 1060, the reset pulses (RST) have the-same polarity and duration as in FIG. 9, but the reset pulses start at the same time. This approach is advantageous because the total image update time can be even shorter for some images. Here, without the rest pulse, image quality problems may occur only for partial image updates.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but should be construed to cover all modifications that may fall within the scope of the appended claims.

1. A method for updating an image on an electronic reading device, the method comprising:
applying at least a first hardware driving pulse (S1, S2) to a bi-stable display (3 10) of the electronic reading device; and
applying at least one rest pulse (R1, R2) temporally adjacent to and following the at least a first hardware driving pulse.

2. The method of claim 1, wherein:
the at least one rest pulse (R1, R2) has a voltage level that is below a threshold for moving particles that form the bi-stable display (310).

3. The method of claim 1, wherein:
a frame time of the at least one rest pulse (R1, R2) is substantially equal to a frame time of the at least first hardware driving pulse (S1, S2).

4. The method of claim 1, wherein:
applying the at least one rest pulse (R1, R2) comprises applying the at least one rest pulse to only a portion (510, 520) of the bi-stable display (310, 500) to provide a partial image update.

5. The method of claim 1, wherein:
applying the at least one rest pulse (R1, R2) comprises applying the at least one rest pulse to the entire bi-stable display.

6. The method of claim 1, wherein the at least a first hardware driving pulse is a hardware shaking pulse.

7. The method of claim 6, further comprising:
applying a reset pulse (RST) preceding the at least a first hardware driving pulse (S1, S2).

8. The method of claim 6, further comprising:
applying a reset pulse (RST) to the bi-stable display;
wherein, applying at least a first hardware driving pulse comprises applying a first hardware driving pulse (S1) preceding the reset pulse, and applying a second hardware driving pulse (S2) following the reset pulse, and applying at least one rest pulse comprises applying a first rest pulse (R1) following the first hardware driving pulse, and applying a second rest pulse (R2) following the second hardware driving pulse.

9. The method of claim 8, wherein:
the first and second rest pulses (R1, R2) have a frame time substantially equal to a frame time of the first and second hardware driving pulses (S1, S2).

10. A program storage device tangibly embodying a program of instructions executable by a machine to perform a method for updating an image on an electronic reading device, the method comprising:
applying at least a first hardware driving pulse (S1, S2) to a bi-stable display (310) of the electronic reading device (300); and
applying at least one rest pulse (R1, R2) temporally adjacent to and following the at least a first hardware driving pulse (S1, S2).

11. The device of claim 10, wherein the at least a first hardware driving pulse (S1, S2) is a hardware shaking pulse.

12. An display device, comprising:
a bi-stable display (310); and
a control (100) for updating an image on the bi-stable display by applying voltage waveforms to the bi-stable display, including at least a first hardware driving pulse (S1, S2) and at least one rest pulse (R1, R2) temporally adjacent to and following the at least a first hardware driving pulse (S1, S2).

13. The display device of claim 12, wherein:
the at least one rest pulse (R1. R2) has a voltage level that is below a threshold for moving particles that form the bi-stable display (3 10).

14. The display device of claim 12, wherein:
the voltage waveforms applied to the bi-stable display further include a reset pulse (RST) preceding the at least a first hardware driving pulse (S1, S2).

15. The display device of claim 12, wherein:
a frame time of the at least one rest pulse (R1, R2) is substantially equal to a frame time of the at least a first hardware driving pulse (S1, S2).

16. The display device of claim 12, wherein:
the at least one rest pulse (R1, R2) is applied to only a portion (510, 520) of the bi-stable display to provide a partial image update.

17. The display device of claim 12, wherein:
the at least one rest pulse (R1, R2) is applied to the entire bi-stable display.

18. The display device of claim 12, wherein:
the voltage waveforms applied to the bi-stable display further include a reset pulse (RST);
the at least a first hardware driving pulse (S1, S2) comprises a first hardware driving pulse (S1) preceding the reset pulse, and a second hardware driving pulse (S2) following the reset pulse;
the at least one rest pulse comprises a first rest pulse (R1) following the first hardware driving pulse, and a second rest pulse (R2) following the second hardware driving pulse.

19. The display device of claim 18, wherein:
the first and second rest pulses (R1, R2) have a frame time substantially equal to a frame time of the first and second hardware driving pulses (S1, S2).

20. A control (100) comprising a logic circuit configured to update an image on a bi-stable display by applying voltage waveforms to the bi-stable display, including at least a first hardware driving pulse (S1, S2) and at least one rest pulse (R1, R2) temporally adjacent to and following the at least a first hardware driving pulse (S1, S2).
